(19) United States
(12) Patent Application Publication
(10) Pub. No.: US 2007/0101555 A1
(43) Pub. Date: May 10, 2007

(54) Line clutch with quick release

(76) Inventor: Peter Harwardt, Joliet, IL (US)

Correspondence Address: Ms. Soula Skokos, Suite 220, 1100 Jorie Boulevard, Oak Brook, IL, 60523, US

(21) Appl. No.: 11/582,228

(22) Filed: Oct. 17, 2006

Related U.S. Application Data
(60) Provisional application No. 60/733,683, filed on Nov. 4, 2005.
(60) Provisional application No. 60/789,331, filed on Apr. 4, 2006.

(51) Int. Cl. F16G 11/00

(52) U.S. Cl. 24/136 R

(57) ABSTRACT

The clutch mechanism of the present invention is constructed such that in an unlocked, free position, a set of pins and linkages are off line and permit a pivotable wedge member to accommodate movement of a line (e.g., rope) that is carried by a rotatable member without causing wedging of the line since the wedge member is moved away from the rotatable member and therefore the line can freely travel through the clutch mechanism. However, when the set of pins and linkages is brought in line, the wedge member moves toward the rotatable member, thereby downsizing the line path and locking the line when the wedge member pivots to cause the line to become wedged between the pivotable wedge surface and the rotatable member.

### CROSS REFERENCE TO RELATED APPLICATION

The present application is a utility application claiming the benefits of the filing date of provisional applications, application No. 60/733,683 filed on Apr. 4, 2006 by the present applicant, and application No. 60/789,331 filed on Nov. 4, 2005 by the present applicant.

### TECHNICAL FIELD

The present invention generally relates to line clutch mechanisms and, more specifically, to a line clutch with a quick release mechanism.

### BACKGROUND

It is frequently necessary to control a line by either arresting or stopping its motion or releasing it. On sailing vessels, for example, lines are used to raise and control sails and other operating units often under heavy loads. The same line may first be lightly loaded, and then as the tension required increases, the use of a winch is necessary. To allow one winch to be used for several lines, of the same or varying sizes, a sheet or line stopper is provided for each line. When out of engagement, the line stopper permits the line to run in both directions. In an engaged position, the line runs under light pressure in one direction only. It is therefore possible to haul a line in by hand without slipping as a self-locking action prevents line movement of the line in the opposite direction. As the load increases, a winch is used to set the line in the desired position as control becomes difficult by hand. With the line stoppers presently available, although the line may be taken off the winch and still be held by the line stopper, it is impossible to release the line without the use of a winch to hold the load while the line stopper is released. In sailboat racing, putting a line on a winch in order to effect a release of the line stopper is time consuming as well as tying up a winch which may be necessary for another control function. Also, the line stopper tends to contact and abrade a line on its release under load even using a winch to help effect such a release.

The prior art is replete with braking mechanisms for arresting or releasing a line under tension. As suggested, such lines are frequently used to hoisting and trimming of sails in which the line may be subjected to tensions ranging from low to extremely high tensions up to and even exceeding ten tons.

A common mechanism for arresting a line includes a cylindrical surface mounted to exhibit an eccentric braking surface in relation to a fixed abutment surface so that movement of the eccentric braking surface can vary or adjust a gap through which the line is guided. When the gap is sufficiently reduced, the line is wedged between the braking and abutment surfaces. Normally, continued tension on the line in the same direction increases the wedging effect and thereby the lock on the line. One example of such a rope holding device is disclosed in U.S. Pat. No. 3,835,507, which shows a cylindrical cam mounted for rotation on a pin to cause the circumferential gripping surface to provide a variable line gap when the cam is rotated. A U-shaped base member having legs with a pilot pin mounted therein is adapted to be anchored on a sailboat. A cam mechanism includes an inner element having a handle attached thereto which is eccentrically mounted for pivotal movement around the pivot pin. A movable outer element is positioned for pivotal movement and a rotational movement on the eccentrically mounted inner element. One or more springs are mounted between the inner and outer elements of the cam mechanism which are acted on when relative movement takes place between the elements. The spring is compressed when the handle is pivoted placing the outer member in locking engagement with the line in the load direction which locking action is increased with increasing load; while allowing the outer member to rotate or float over the line in the other direction. Each release of the load direction is effected by raising the handle. The line stopper can be released under heavy load because the outer element holding the line rotates in the same direction the line is running, the line will not be abraded thereby limiting line wear. The line stopper may be mounted either vertically or horizontally.

A disadvantage of existing rope holding or stopping devices is that they require substantial forces to be applied to release the line after is has been locked. Thus, once the line tension causes the eccentric cam surface to close a gap for the line and wedges it to stop it and lock it continued tension on the line in the same direction tends to decrease the gap even further with attendant increased holding pressure on the line. Releasing the line from its wedged condition can be effected by reversing the process and increasing the size of the gap through which the line extends. Clearly, this can be done in one of two ways. One or the other of the wedging surfaces must be moved away from the other opposing surface so that the gap is increased and the line is again permitted to move. As suggested, the prior art devices have typically used a fixed abutment surface that always remains stationary. Therefore, the only way to increase the gap is to move the surface on the eccentric cam in a direction opposite to the initial direction that caused the cam to lock the line. However, this is not always an easy or quick task. The reason for this is that the tension in the line can be so high that applying an opposing tension on the other end of the line may be difficult if manually attempted. Application of a tension greater than the tension at the opposing end of the line could rotate the eccentric cam in the releasing position with attendant increase in the gap. This approach, however, becomes impractical when the tensions in the line are extremely high. For this reason, a winch must at times be used to overcome very high tensions in the line in order to reverse the direction of movement of the eccentric cam surface and thereby the size of the line receiving gap. In some cases, a handle or lever is used that is attached to the eccentric cam that allows a user to obtain mechanical advantage in moving or rotating the eccentric cam to an unlocking position. See, for example, U.S. Pat. No. 4,425,862 for a sail line stopper that uses a handle that cooperates with the cam. Unlocking the line using the stopper still requires significant effort.

### SUMMARY

The present invention generally relates to the line clutch mechanisms and, more specifically, to a line clutch with a quick release mechanism.

The clutch mechanism of the present invention is constructed such that in an unlocked, free position, a set of pins and linkages are off line and permit a pivotable wedge member to accommodate movement of a line (e.g., rope) that is carried by a rotatable member without causing wedging of the line since the wedge member is moved away from the rotatable member and therefore the line can freely travel through the clutch mechanism. However, when the set of pins and linkages is brought in line, the wedge member moves toward the rotatable member, thereby downsizing the line path and locking the line when the wedge member pivots to cause the line to become wedged between the pivotable wedge surface and the rotatable member.

### BRIEF DESCRIPTION OF THE DRAWING FIGURES

This invention, together with further aspects, features and advantages thereof will be more clearly understood by considering the following description in conjunction with the accompanying drawings in which like elements bear the same reference numerals throughout the several views.

FIG. 1 is a perspective view of a line clutch device in accordance with the present invention in the locked position;

FIG. 2 is a top plan view of the line clutch device in an unlocked or neutral position;

FIG. 3 is an exploded perspective view of a number of the components of the line clutch device of FIG. 1;

FIG. 4 is a side elevation view of the line clutch device in the unlocked position; and

FIG. 5 is another top plan view of the line clutch device in an unlocked or neutral position; and

FIG. 6 is a top plan view of the line clutch device in the locked position.

### DETAILED DESCRIPTION OF EXEMPLARY EMBODIMENTS

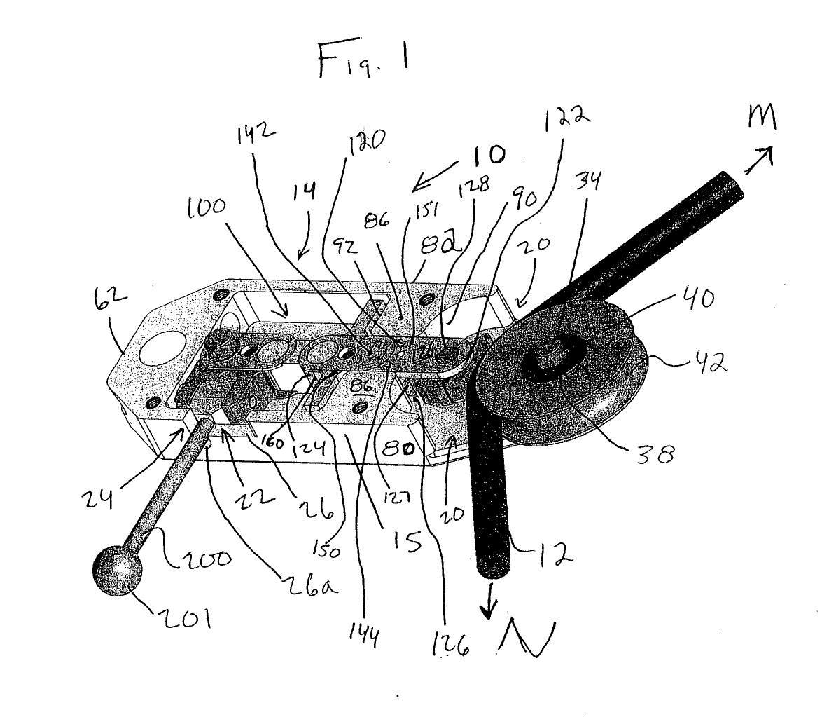

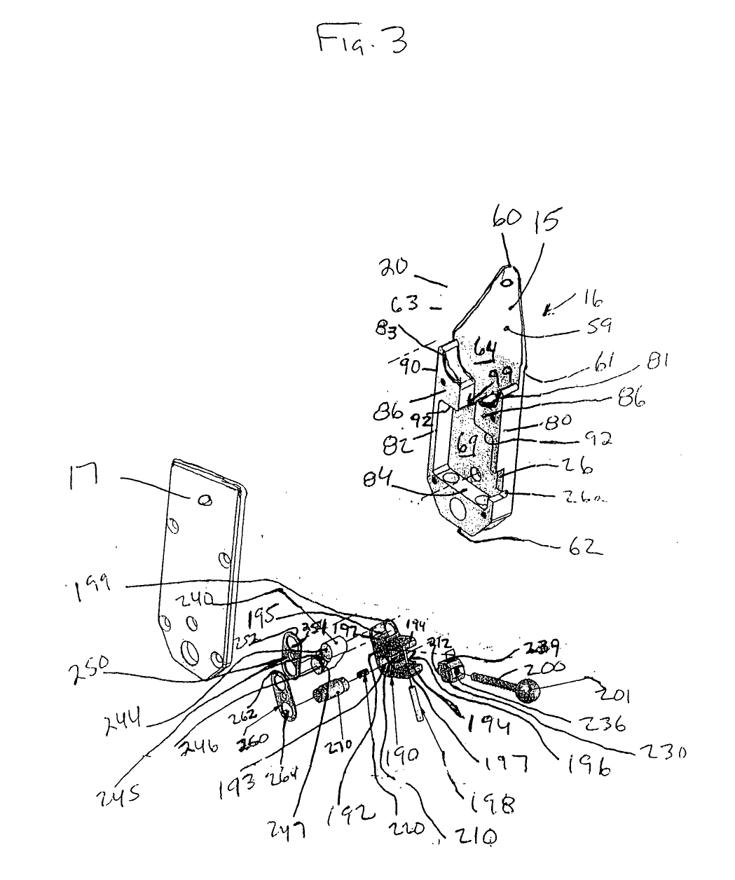

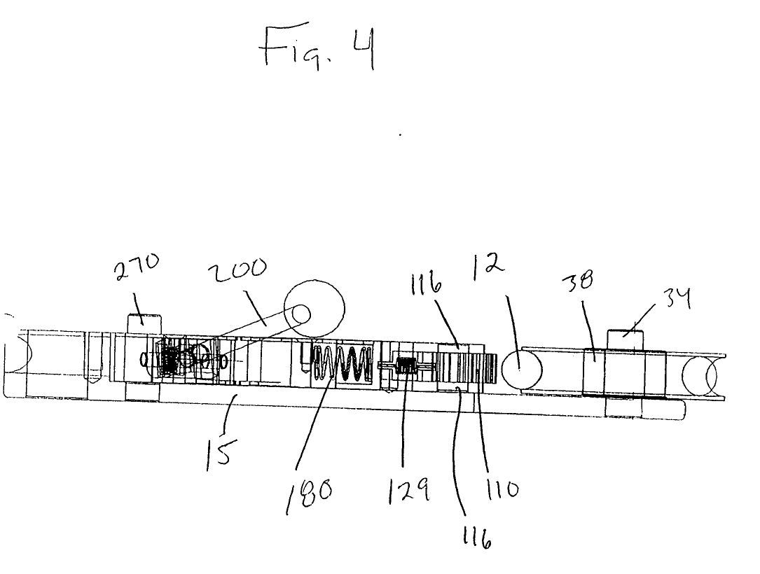

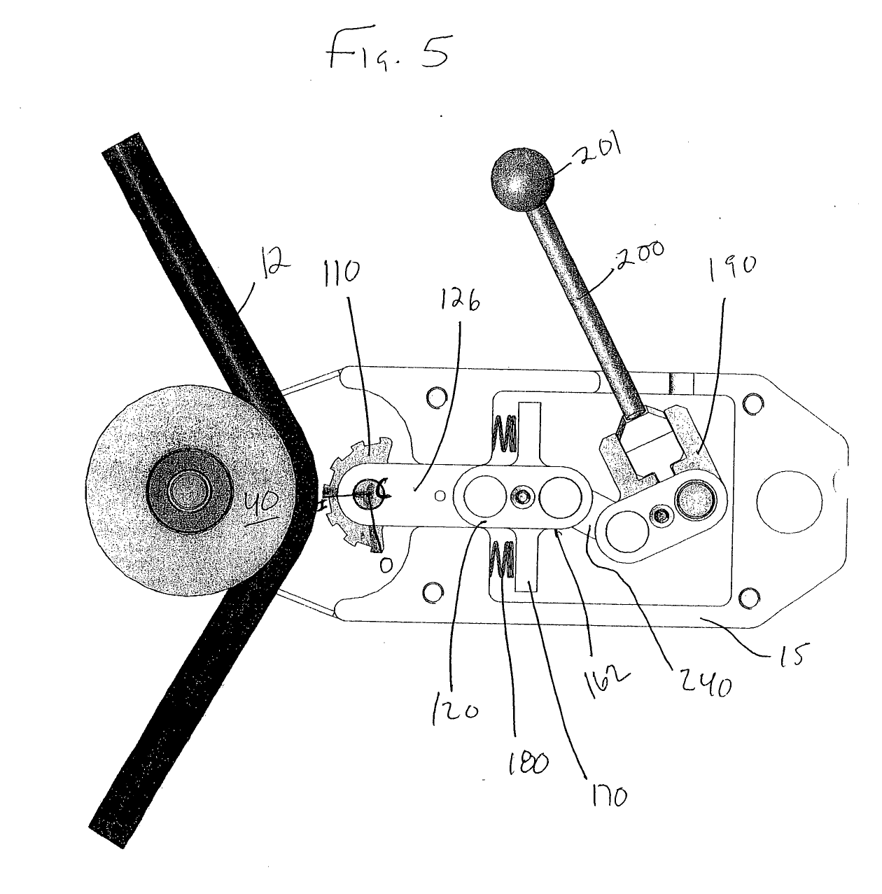

Referring first to FIGS. 1-6, a line clutch or locking device in accordance with the invention is generally designated by the reference numeral 10.

The device 10 serves to selectively clamp, lock, stop or arrest a line 12 while it is under tension and moving in either direction M or N (FIG. 1).

The device 10 includes a housing or case 14 shown to be relatively flat and elongate in one direction in the general plane of the housing. However, it will be evident that the specific configuration of the housing or case is not critical and any convenient or suitable shape or configuration may be used that is consistent with the mounting and operation of the elements or components contained therein to be described.

Generally, the housing or case or chassis 14 includes or defines two sections. The first is a wedging or locking section 16 through which the line 12 to be controlled enters and exits the housing through suitable openings. The other part of the housing defines a control portion 22 which controls the actions that take place in the wedging or locking section 16. The control portion 22 includes a manual control mechanism 24 that extends through a slot 26 and includes a handle 200 that extends through the slot 26 and may be provided with a knob or gripping portion 201. The slot 26 is generally straight and provided with right angle recess or detent 26a at one respective end of the slot, the recess 26a serving as a locking position for the handle 200 that promotes the clamping or locking or stopping of the line 12, as will be more fully described. It will become evident that the specific configuration of the slot 26 and the use of recess or detent 26a is not critical and any other and suitable mechanism, electro-mechanism or circuit may be used to establish and maintain the desired condition of the control portion 22.

In the illustrated embodiment, the housing 14 is actually formed of two parts, namely a base portion 15 that houses and contains most of the working parts of the device 10 and a cover 17 that is secured thereto along an upper edge of the base potion 15. The base portion 15 includes a first end 60 and an opposing second end 62, with a first compartment 64 that defines the wedging section 16 being formed at or proximate the first end 60. The first compartment 64 is defined by a floor 59 that terminates at the first end 60. The first compartment 64 is open at the first end 60, as well as the sides 64 thereof to permit reception and movement of the line 12. When the cover 17 is attached to the base portion 15, a pair of opposing side slots 20 is formed in the first compartment 64 to accommodate the travel and movement of the line 12.

The base portion 15 also includes a pair of opposing side walls 80, 82 that extend upwardly from the floor 59 along peripheral side edges of the base portion 15. More specifically, the side walls 80, 82 extend from a bottommost portion of the first compartment 64 all the way to the second end 62 which includes a transverse wall 84 that extends between the side walls 80, 82. The side walls 80, 82 contain side wall protrusions 86 that are formed along a length thereof and protrude inwardly from an inner surface of the side walls 80, 82. The pair of side wall protrusions 86 is preferably opposite one another at the same locations along their respective side walls 80, 82. The side walls protrusions 86 serve to define and mark the boundary between the first compartment 64 and a second compartment 69 that contains the control portion 22. While the side wall protrusions 86 can take any number of different shapes, the illustrated side wall protrusions 86 are generally block-shaped structures. Each side wall protrusion 86 has a top side or top face 90 that faces the first compartment 64 and an opposite underside or lower face 92 that faces the second compartment 69. The second compartment 69 generally has a square or rectangular shape.

The slot 26 is formed in the side wall 80 to permit operation of the device 10 as described below.

A plurality of clutch devices 10 can be stacked to make efficient use of space while accommodating three lines 12. Each of the devices 10 may be similarly constructed and, accordingly, may be provided with independent control portions 22. These units may be secured to each other in any conventional way. The construction and operation of each of the units is the same and the description that follows in connection with FIGS. 1-6 is applicable to each of the units.

Referring to FIGS. 1-3, one exemplary embodiment, by way of example, is illustrated and described below. The wedging or locking part 16 of the clutch device 10 includes a fixed pin or rivet 34 that can also be used to secure two or more of the units to each other. The pin or rivet 34 is fixed to the base 15 and cover 17 of the housing 14 and defines a center or “axis” of rotation 36. Rotatably mounted on the pin or rivet 34 is a bearing 38 that can freely rotate about the fixed center or “axis” 36. Mounted on the bearing 38 is a rotatable wheel 40. The wheel 40 is thus mounted to the floor 59 of the first compartment 64 and more specifically, the wheel 40 is mounted at or near the first end 60. The wheel 40 can be mounted such that a first portion thereof is disposed in the first compartment 64, while a second portion thereof extends beyond the first end 60 since the wheel 40 is disposed and mounted above the floor 59 and thus can extend or protrude beyond the end 60 of the floor 59.

The wheel 40 is constructed so that it includes an outer circumferential groove 42 (guide track) for receiving the line 12. The circumferential groove 42 has an arcuate shape and in particular, the groove 42 has a concave shape that is complementary to the circular shape of the line 12 to permit the line 12 to be snugly received within the groove 42 (guide track) and whereupon, movement of the line 12 causes rotation of the wheel 40. The wheel 40 is thus mounted in the middle section of the floor 59 at or near the end 60. In one embodiment of the present invention, the wheel 40 can be removable and interchangeable with a wheel of a smaller or larger diameter and corresponding outer circumferential groove 42 (guide track) to accommodate various sized ropes and lines.

As will become evident, the stopping, locking or clamping action on the line 12 occurs when it is wedged within gap or space 50 between the wheel 40 and an opposing surface to be described.

The line clutch device 10 of the present invention includes a line clutch mechanism 100 (control portion 22) which is a mechanical device that is operable to either tie or release the line 12 (e.g., rope) as will be described in detail below. The line clutch mechanism 100 includes a rotatable/pivotal wedge member 110 that has an arcuate inner surface 112 that faces the wheel 40. The inner surface 112 of the wedge member 110 in combination with the wheel 40 defines the space 50 in which the line 12 is wedged when the line clutch mechanism 100 is in the locked position and the wedge member 110 is rotated so that it assumes a position that causes the line 12 to be securely wedged within the gap 50 as described below. The wedge member 110 is in the form of a body 114 that preferably includes one or more bosses 116 that extend outwardly therefrom in the form of a projection. In the illustrated embodiment, the boss 116 has a circular shape and resembles a pivot pin that extends outwardly from the body 114. For example, one boss 116 can be formed on a top surface of the body 114, while the other boss 116 can be formed on a bottom surface of the body 114. The two bosses 116 are axially aligned in thus defines a common axis about which the body 114 can pivot as described below.

The inner surface 112 of the body 114 is a toothed surface in that a plurality of teeth or teeth-like structure 118 are formed along the inner surface 112 of the body 114. The teeth 118 provide gripping structures and define a roughened, uneven surface that engages and helps urge the line 12 against the wheel 40 and as the body 114 rotates, the line 12 is wedged against the wheel 40. As with the other components of the line clutch mechanism 100, the wedge member 110 is typically formed of a metal material; however, it will be understood that it may be formed from other materials that are suitable for the intended function.

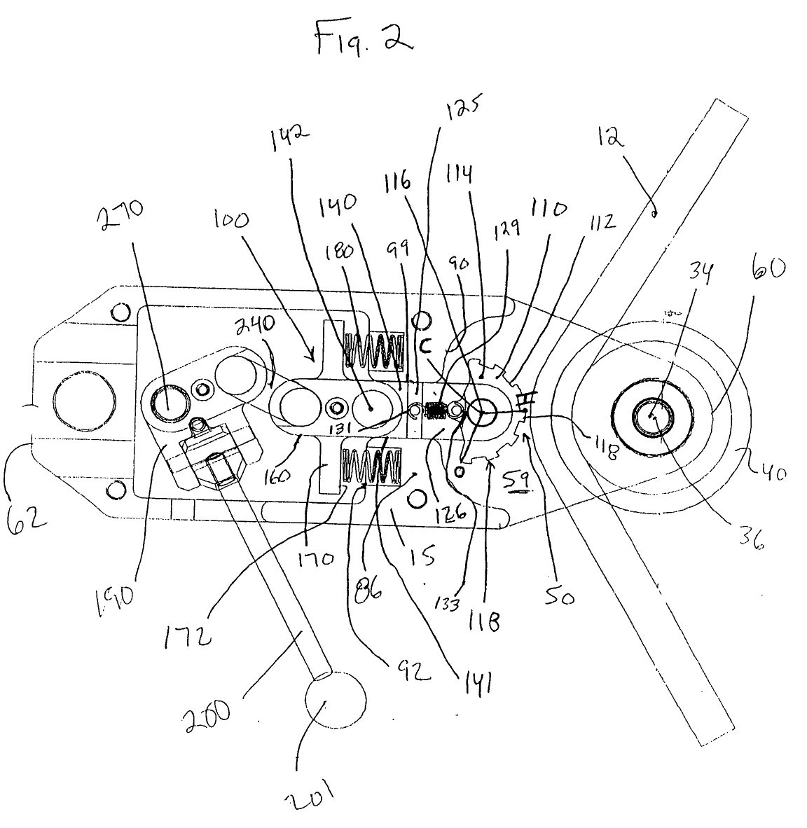

While the body 114 is arcuate in nature, it does not define a complete circle but rather has a shape that is more semi-circular in nature. In other words and as illustrated, the body 114 extends about 180 degrees and can be slightly greater than 180 degrees, as illustrated, but still less than 270 degrees. In addition, the radial distances from the pivot axis of the body 114 to the outer surface of each tooth 118 are not uniform but rather the radial distances are great at and near the ends 119 of the body 114. As illustrated in FIG. 2, a radial distance from the innermost teeth 118 to the center axis of rotation C, as measured by distance I-C, is less than a distance from the teeth in end region 119 to the center axis C, as measured by distance O-C.

Thus, in an engaged state, when the body 114 is pivoted so that one end 119 is in a 12 o'clock position, the distance between point R of the wheel 40 and the teeth 118 located at and proximate the ends 119 of the body 114 is less than the distance between point R and the inner teeth 118 of the body 114 when the inner teeth 118 are in the 12 o'clock position. This construction permits the line 12 to be wedged between the wheel 40 and the end regions 119 of the body 114 as described below.

The line clutch mechanism 100 also includes a guide member 120 that has a first end 122 and an opposing second end 124. At the first end 122, the guide member 120 has an elongated upper section that is formed by a pair of arms or fingers 126 that are spaced apart from one another to define a space 127 therebetween. Each of the arms 126 terminates in an arcuate (rounded) end that defines the first end 122. The arms 126 are superimposed with respect to one another (overlying relationship) and extend axially within the mechanism 100. Each of the arms 126 has an opening 128 formed therethrough near the arcuate first end 122. The openings 128 are axially aligned with one another so as to define an axial through opening through the guide member 120, with this axial opening 128 constructed to receive the bosses 116 of the body 114 of the urging element 112 so as the rotatably (pivotally) mount the urging element 112 to the guide member 120 at its end 122 thereof.

The upper section that is defined by the arms 126 is integrally connected to a base section 140 of the guide member 120. The base portion 140 includes a first boss 142 in the form of a slightly raised protuberance which in this case has a circular shape and is spaced from an arcuate lip or edge 144 of the base portion 140. The base portion 140 has a generally planar first face 150 that is formed around the first boss 142 and extends from the arcuate edge 144 to the end 122 of the guide member and thus, the edge 144 resembles a shoulder between two stepped portions defining the guide member 120. The planar second face 151 thus defines one (the upper) arm 126.

At the end 124, the guide member 120 has a pair of arcuate walls 160 that are spaced oppositely apart one another so as to define a receiving space or compartment 162 that is also defined by a floor section of the guide member 120. In other words, the space 162 does not include a ceiling and is thus open but is otherwise defined by the pair of arcuate walls 160 and the floor. Proximate the end 124, the guide member 120 includes a pair of opposing side flanges or fingers 170 that extend outwardly from the base portion 140 toward the sides of the housing 14. The side flanges 170 are axially aligned with one another and each forms a right angle with the base portion 140. Preferably, each side flange 170 includes a planar inner surface or face 172 which faces an underside 92 of the side wall protrusions 86.

The guide member 120 is disposed within the base 15 of the house 14 such that the arms 126 extend through an axial channel 99 formed between the side wall protrusions 86 and at least partially into the first compartment 64. The dimensions of the arms 126 are thus complementary to the dimensions of the axial channel 99 to permit reception therein and to permit axial movement of the guide member 120 (arms 126) within the axial channel 99. At least the upper portions (end 122) of the arms 126 are disposed on one side (a top side) 90 of the side walls protrusions 86, while the side flanges 170 are disposed on the opposite side (the underside) 92 of the side wall protrusions 86. In this manner, the top sides 90 of the side wall protrusions 86 define a stop for the axial movement of the guide member 120 and the wedge member 110 in a direction toward the end 62 of the housing 14. As shown in FIG. 2, the upper edge portions 81, 83 are arcuate surfaces (concave) surfaces that define the respective top sides 90 of the side wall protrusions 86 and since the dimensions of the urging element 110 are greater than the dimensions of the width of the axial channel 99, the edge portions 81, 83 restrict the axial movement of the coupled wedge member 110 and guide member 120 by acting as a stop. Similarly, the underside 92 of the side wall protrusions 86 acts as a stop surface for the side flanges 170 and restricts axial movement thereof in the opposite direction toward the end 60.

The underside 92 of the side wall protrusions 86 also serves another purpose in that it provides a planar surface that is opposite the planar surfaces 172 of the side flanges 170 and thus permits a biasing member 180 to be disposed between one side flange 170 and the respective underside 92 of the side wall protrusion 86. As described below, the biasing members 180 serve to bias the line clutch mechanism 100 to the open or unlocked position illustrated in FIG. 2. In one embodiment, the biasing member 180 are in the form of coil springs that are disposed against and between the planar surfaces of the side flanges 170 and the undersides 92 of the side wall protrusions 86. In the unlocked position of the clutch mechanism 100, the stored energy of the biasing members 180 has been at least substantially released, while in the locked position, energy is stored in the biasing member 180.

Similar to the wedge member 110, the base portion 140 of the guide member 120 is sized to fit within the axial channel 99 formed between the side wall protrusions 86. Side walls 141 of the base portion 140 slidingly travel along the inner surfaces or walls of the side wall protrusions 86.

The wedge member 110 is coupled to the guide member 120 in a biased manner and in particular, by means of a biasing element 129. The guide member 120 includes a transverse wall 125 that extends across a width of the space 127 formed between the arms 126. More specifically, the transverse wall 125 is formed near the location of the arcuate edge 144 facing the first end 122. The transverse wall 125 includes a feature for securing one end 131 of the biasing element 129. For example, the transverse wall 125 can contain an open catch or pin structure that receives and engages a complementary structure of the biasing element 129.

The other end 133 of the biasing element 129 is coupled to a base section 111 of the wedge member 110. In one exemplary embodiment, the biasing element 129 is in the form of a spring that has two hook structures at its opposite ends to permit the spring 129 to be attached to and between the fixed transverse wall 125 and the rotatable wedge member 110. One hook (e.g., open circular shaped hook) of the spring 129 is attached to a circular pin structure that protrudes upwardly from either the transverse wall 125 or if there is no transverse wall 125, then the pin can extend upwardly from the floor defined by the bottom or lower arm 126. Similarly, the base section 111 of the wedge member 110 can contain a pin structure that extends upwardly therefrom for engagement with a hook (e.g., open circular shaped hook) at the other end of the biasing element 129. Between the hooks is the spring, such as a coil spring.

When the spring 129 is in its rest position, the spring 129 biases the wedge member 110 into a position where the innermost teeth are orientated in the 12 o'clock position as shown in FIG. 2. The spring 129 is biased such that when a force is applied thereto (e.g., as by movement of the line 12 in direction N or M when the wedge member 110 engages the line 12), the spring 129 stores energy as the wedge member 110 rotates in either a clockwise direction or counterclockwise direction. As soon as the stored energy is released, as when the wedge member 110 is disengaged from the line 12 and the wedge member 110 can freely rotate back to its rest position, the wedge member 110 rotates back to the orientation shown in FIG. 2 where the innermost teeth 118 are in the 12 o'clock position. In the rest position, the innermost teeth 118 are again ready for engagement with the line 12 when the clutch mechanism 100 is placed into the locked position. The spring 129 is thus provided to restore the spring 129 to the rest position shown in FIG. 2. The biasing force also ensures a smooth movement of the wedge member 110 as it rotates due to movement of the line 12 in either the M direction or the N direction.

The clutch mechanism 100 also includes a pivot housing 190 that is defined by a body portion 192 that has a pair of opposing flanges 194 that extend therefrom and are spaced apart from one another so as to define a channel or space 196 therebetween for receiving a handle 200 as described below. Preferably, the opposing flanges 194 are parallel to one another and are formed at right angles with respect to the body portion 192. Each of the side flanges 194 has a bore 197 formed therethrough so as to form an entrance into the space 196. The two bores 197 are opposite one another and axially aligned with one another to permit a first shaft or pin 198 to extend therethrough across the space 196 for pivotally holding the handle 200 of the clutch mechanism 100.

The body portion 192 also includes a slot or channel 210 formed therein at a location between the side flanges 194 and one which faces the space 196 and in fact is open to the space 196. The slot 210 is defined by a floor as well as opposing side walls so as to define a vertical space that receives a handle biasing member 220 as well as a nub or protrusion 212 that is part of a handle block 230. More specifically, the handle block 230 includes the nub 212 at one end thereof, while the opposite end includes a bore 236 for securely receiving one end of the elongated handle 200. For example, the bore 236 can be a threaded bore and the respective end of the elongated handle 200 can include complementary threads such that the handle 200 can be threadingly attached to the handle block 230. It will be appreciated that the other types of attachment techniques can be used to securely fix the handle 200 to the handle block 230 including but not limited to other types of mechanical fits, such as a frictional fit, etc.

The handle block 230 also includes a transverse bore 239 that extend therethrough and is sized to receive the first shat 198. Accordingly, when the handle block 230 is disposed within the space 196, the transverse bore 239 axially aligns with the bores 197 to permit the first shaft 198 to pass therethrough so as to pivotally attach the handle block 230 to the pivot housing 190. The handle biasing member 220 (e.g., a spring) is disposed within the slot 210 so as to apply a biasing force against the nub 212 of the handle block 230, thereby biasing the handle block 230 and handle 200 in an up position. The handle biasing member 220 is thus disposed between the floor 202 and the nub 212. In this manner, the handle block 230 not only pivots about an axis defined by the first shaft 198 but also is biased in up position to assist the handle 200 being placed into the locked position as described below.

The elongated handle 200 preferably includes a knob element 201 or the like at an end opposite the end which is fixedly secured to the handle block 230. The knob 201 assists the user in grasping and manipulating the handle 200 so as to permit the clutch mechanism 100 to be moved between the locked position and the unlocked position.

The pivot housing 190 also includes a through bore 193 through the body portion 192 proximate but not in communication with the slot 210 and the space 196. The body portion 192 of the pivot housing 190 also includes a receiving space 195 that is defined in part by an arcuate wall 197 and a floor 199 which contains an opening or bore 201 formed therethrough. The receiving space 195 is similar and complementary to the receiving space or compartment 162 associated with the guide member 120.

The clutch mechanism 100 further includes several linkages that pivotally and operably connect the pivot housing 190 to the guide member 120. More specifically, a pivot block 240 is provided and is generally in the shape of an oval or a block that has a pair of rounded ends 242. The pivot block 240 also includes a second boss 244 and a third boss 246 that extend above a planar upper surface 245 of the pivot block 240. In the illustrated embodiment, each of the bosses 244, 246 has a circular shape to permit pivoting of the block 240 relative to both the pivot housing 190 and the guide member 120; however, the other shapes may be possible. The planar surface 245 between the two bosses 244, 246 is thus recessed relative to the bosses 244, 246 themselves and has a pair of arcuate (concave) edges or surfaces 247 that face the bosses 244, 246.

The pivot block 240 acts as a linkage between the pivot housing 190 and the guide member 120 and in particular, one rounded end 242 is received within the receiving space 195 associated with the pivot housing 190, while the other rounded end 242 is receive din the receiving space 162 associated with the guide member 120. The boss 244 that is received in the receiving space 162 of the guide member 120 is pivotally attached to the guide member 120 by means of the first pivot plate 250 which is in the form of a planar plate that has rounded ends 252 that are complementary to the arcuate edge 247 and the arcuate edge 144 of the guide member 120. The first pivot plate 250 has a pair of openings 254 formed therethough proximate the rounded ends 252. The openings 254 are complementary to the boss 242 of the pivot block 240 and the boss 142 of the guide member 120 such that the bosses 242, 142 are received therethrough so as to fixedly yet pivotally connect the pivot block 240 to the guide member 120. A fastener or the like can be used to fixedly secure the first pivot plate 250 to the guide member 120. For example, a screw or the like can be received within an opening that is formed within the guide member 120 between the side flanges 170.

It will be appreciated and described in more detail below that the manner of linking the pivot block 240 to the guide member 120 permits the pivot block 240 to freely pivot relative to the guide member 120, while the guide member 120 moves within the channel 99 and along axis 88.

Similarly, a second pivot plate 260 is provided and is similar to the first pivot plate 250 in that it is in the form of a planar plate that has rounded ends 262 that are complementary to the arcuate edge 247 of the guide member 120. The second pivot plate 260 has a pair of openings 264 formed therethrough proximate the rounded ends 262. The openings 264 are complementary to the boss 244 of the pivot block 240 and a main shaft 270 that is received within and through the through bore 193 of the body portion 192 of the pivot housing 190 and then through an opening 19 formed in the floor of the base 15 of the assembled housing 14, as well as an opening 21 formed in the cover 17, so as to be fixedly connected to the housing 14. In other words, the main shaft 270 is stationary and does not rotate relative to the base 15 or any other component for that matter, but rather, the pivot housing 190 pivots thereabout. The pivot housing 190 is pivotally attached to the stationary shaft 270 by the second pivot plate 260 which acts as a linkage between the two components.

As with the first pivot plate 250, a fastener or the like can be used to fixedly secure the second pivot plate 260 to the pivot housing 190. For example, a screw or the like can be received within an opening that formed within the pivot housing 190 between the through bore 193 and the receiving space 195.

The operation of the clutch device 10 will now be described in connection with FIGS. 1-6. In FIG. 2, the control portion 22 is set to allow the line 12 to move in either direction M or N. As the line 12 moves through the clutch device 10, the frictional engagement of the line 12 with the wheel 40 causes the wheel to rotate either in a clockwise direction, if the line is moving in the direction M or in a counter-clockwise direction if the line moves in the opposite direction N. For purposes of the illustration it will be assumed that the line 12 is tensioned and moves in the direction N.

In the unlocked position, the wedge member 110 is sufficiently spaced from the line 12 such that it does not engage the line 12 and therefore, the line 12 is free to move about the wheel 40. In addition, in the unlocked position, the guide member 120 can slide axially through the channel 99 toward the second end 62 without any resistance (since this is not against the biasing force applied by the springs 180), and consequently, the gap or space 52 for the line 12 remains substantially the same and the line 12 is not wedged, stopped or arrested in any way. This will continue until a decision is made to stop, arrest, or clamp the line 12.

It will be appreciated that in the unlocked position shown in FIG. 2, the handle 200 is all the way or close to the right end of the slot 26 and the pivot housing 190 is pivoted about the fixed (stationary) main shaft 270 such that the pivot block 240 and second pivot plate 260 are not axially aligned with the first pivot plate 250 and base portion 140 of the guide member 120 but rather are offset therefrom (“offline”), thereby permitting the biasing members 180 to be in a relaxed state (stored energy is released) which results in the guide member 120 and the wedge member 110 that is coupled thereto being sufficiently spaced from the wheel 40 to permit free movement of the line 12 as the wheel 40 rotates due to a pulling or pushing action on the line 12 in either clockwise or counterclockwise directions. The handle 200 is biased in an up position due to the release of stored energy of the handle biasing member 220 against the nub 212 of the handle block 230.

To move the clutch mechanism 100 to the locked position shown in FIG. 1, the operator simply moves the handle 200 within the slot 26 toward the left end and the detent 26a until the handle 200 engages the detent 26a. As the handle 200 travels in the slot 26 in this direction, the pivot housing 190 is caused to pivot in an opposite direction (clockwise direction) about the fixed (stationary) main shaft 270 since the handle 200 is coupled to the pivot housing 190 by means of the handle block 230. As soon as the handle 200 is aligned with the detent 26a, the biasing force of the handle biasing member 220 causes the handle 200 to be directed into the detent 26a since this position of the handle 200 over the detent 26a permits a release of the stored energy of the biasing member.

As the pivot housing 190 pivots in this clockwise direction about pivot 270, the pivot block 240 pivots relative to both the pivot housing 190 and the guide member 120 due to the reception of the bosses 244, 246 in the respective openings of the first and second pivot plates 250, 260. As the pivot housing 190 pivots in this manner, both the pivot block 240 and the second pivot plate 260 pivot into a position where they are axially aligned with the first pivot plate 250 and the base portion 140 of the guide member 120 (“in line”) which results in a force being applied to the guide member 120 in a direction toward the first end 60. This force is sufficient to overcome the biasing force of the biasing members 180, thereby causing the biasing member 180 to compress between the side flanges 170 and the side wall protrusions 86. It will thus be appreciated that as soon as the pivot block 240 is moved to the aligned position along the “axis A”, the guide member 120 and wedge member 110 are prevented from the unrestricted movements toward the second end 62.

In this “in line” position, the urging element 110 is placed into contact and engagement with the line 12. However, when the inner teeth 118 of the body 114 engage the line 12, there is some play for further movement of the line 12. Now, as the line 12 is moved further and the wheel 40 rotates, the wedge member 110 rotates/pivots in an opposite direction. For example, when the line 12 moves in direction N, the wheel 40 rotates in a counterclockwise direction, while the wedge member 110 results in the end region 119 moving towards the 12 o'clock position where the distance between point R of the wheel 40 and the teeth 118 (point O) is at a minimum.

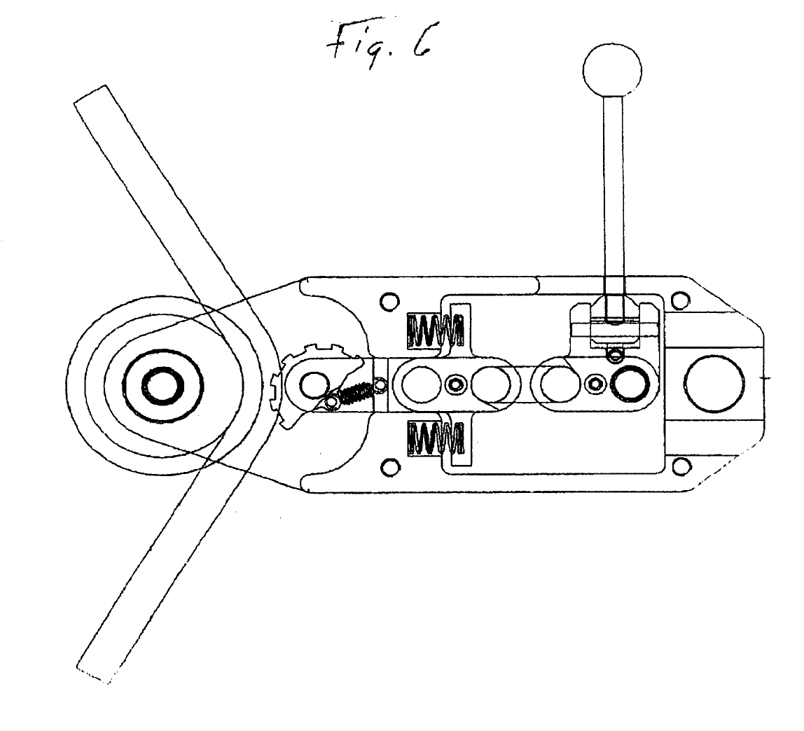

The continued rotation of the wedge member 110 causes an increasing reduction in the size of the gap or space 52. This causes a wedging effect and the line 12 is abruptly stopped when the wedge member 110 is rotated to bring one end 119 to a predetermined position(s) (e.g., when the end 119 (point O) is in a position between 10-12 o'clock positions in FIGS. 1 and 6). As will be appreciated, the pivot block 240 and the pivot housing 190 together from a toggle joint. Such a joint, formed of the two arms or links, can be used to implement a “snap-action” when the links are moved out of alignment. However, when in alignment such arms or links can be used to apply significant pressures at both ends by forcing the arms or links into straight alignment when the ends of the arms or links are constrained or fixed in place.

As the end region 119 rotates closer to the 12 o'clock position, the distance between the wedge member 110 and the wheel 40 decreases to a point where the line 12 is attested/stopped due to the wedging action. In this position, no further movement of the line 12 in the N direction is possible. It will be appreciated that when the innermost teeth 118 of the wedge member 110 (point I) are in the 12 o'clock position, the wedge member 110 is rotated less than 90 degrees to cause the line 12 to be stopped due to the movement of the end region 119 toward the 12 o'clock position.

One of the advantages of the present mechanism 100 is that the degree of play in the opposite direction, in this case direction M, is minimized and optimized due to the construction of the wedge member 110 and the wheel 40 and more particularly, due to the restricted degree of rotation of the wedge member 110 relative to the line 12. If the line 12 is moved in the opposite direction M from is locked position in the direction N, the wheel 40 and the wedge member 110 rotate in the opposite directions such that the inner teeth 118 move through the 12 o'clock position and the other end 119 of the body 114 moves toward the 12 o'clock position until the end 119 rotates enough to case a wedging of the line 12.

It will thus be appreciated that the clutch mechanism of the present invention is constructed such that in the unlocked, free position, a set of pins and linkages are off line and permitting a cam surface to accommodate the movement of the wheel that carries the line (e.g., rope) and wedge member without causing wedging of the line since the teeth are spaced away from the wheel; however, when the set of pins and linkages is brought in line, the wedge member is moved toward the wheel, thereby downsizing the line path and locking the line when the wheel rotates causing the line to become wedged between the wedge member and wheel.

While manual controls have been described, it will also be understood that remote or wireless controls of the “blocking” elements can be used to thereby cause locking, wedging or stopping of the line by a remote user or even by a programmed controller that senses when such action should take place and a blocking element be interposed that will results in wedging or stopping of the line.

In one embodiment of the present invention, the wheel 40 can be removable and interchangeable with a wheel that is a full circular wheel or a semi-circular wheel to accommodate the expected backlash.

Since other changes and modifications varied to fit particular operating requirements and environments will be apparent to those skilled in the art, the invention is not considered limited to the examples chosen for purposes of illustration, and includes all changes and modifications which do not constitute a departure from the true spirit and scope of this invention as claimed in the following claims and equivalents thereto.

What is claimed is:

1. A line clutch device for selectively clamping a line subjected to tension and movable between an unlocked position where the line is free and a locked position where the line is clamped, comprising:
a first rotatable member that engages the line as it is manipulated by a user;
a wedge member that is pivotally coupled to a guide member and includes a first surface that urges the line against the first rotatable member when the device is in the locked position so as to prevent further movement of the line in at least one direction;
a first linkage that is operably and pivotally coupled to the guide; and
a second linkage to which a handle is coupled, the first linkage being pivotally coupled to the first linkage, the second linkage being pivotal about a fixed pivot point such that when the first and second linkage are axially aligned with the guide member, the device moves into the locked position as a result of pivotable wedge member moving towards the first rotatable member, thereby locking the line when the pivotable wedge member pivots a prescribed number of degrees causing the line to become wedged between the first surface and first rotatable member.

2. The device of claim 1, wherein the first rotatable member comprises a wheel.

3. The device of claim 1, wherein the first surface is an arcuate shaped toothed surface.

4. The device of claim 1, wherein the prescribed number of degrees is less than 90 degrees from a rest position of the wedge member.

5. The device of claim 1, wherein the wedge member pivots about axis C, wherein a radial distance from the first surface to axis C is greater at first and second end regions of the wedge member compared to an inner region of the first surface.

6. The device of claim 1, wherein the first surface is an arcuate shaped toothed surface and wherein in a rest position, when an inner region of the toothed surface is in a 12 o'clock position where the distance between the inner regions and the first rotatable member is at a minimum, the wedge member is free to pivot the prescribed number of degrees causing end regions of the toothed surface to rotate toward a 12 o'clock position where the distance between the end region and the first rotatable member is at a minimum resulting in the line being clamped and locked.

7. The device of claim 1, wherein the pivotable wedge is biased to the guide member such that in a rest position, the pivotable wedge is orientated such that an inner region of the first surface is in a 12 o'clock position where the distance between the inner region and the first rotatable member is at a minimum.

8. The device of claim 1, wherein the device may be remotely actuated to move between an unlocked position and a locked position.

9. The device of claim 7, wherein the guide member includes a pair of arms spaced apart with at least a portion of the wedge member being received between the arms, the wedge member being pivotally coupled to the arms, the second linkage being pivotally coupled to the guide member.

10. The device of claim 6, wherein pivoting the wedge member from the rest position to a position where one end region is moved closer to the first rotatable guide member results in a decrease in the distance between the first rotatable member and the wedge member until further movement of the line in one direction is not possible.

11. The device of claim 6, wherein the guide member is biased within a housing of the line clutch device such that in a rest position, with stored energy released, the wedge member is drawn away from the first rotatable member.

12. The device of claim 11, wherein the guide member is in the rest position, the pivotable wedge is the rest position.

13. A system of line clutch devices for selectively clamping a line subject to tension and movable between an unlocked position where the line is free and a locked position where the line is clamped wherein at least two line clutch devices are in line, each line clutch device comprising:
a first rotatable member that engages the line as it is manipulated by a user;
a wedge member that is pivotally coupled to a guide member and includes a first surface that urges the line against the first rotatable member when the device is in the locked position so as to prevent further movement of the line in at least one direction;
a first linkage that is operably and pivotally coupled to the guide; and
a second linkage to which a handle is coupled, the first linkage being pivotally coupled to the first linkage, the second linkage being pivotal about a fixed pivot point such that when the first and second linkage are axially aligned with the guide member, the device moves into the locked position as a result of pivotable wedge member moving towards the first rotatable member, thereby locking the line when the pivotable wedge member pivots a prescribed number of degrees causing the line to become wedged between the first surface and first rotatable member.

14. A system as defined in claim 13, wherein said clamps are secured to each

15. A line clutch device comprising clamping means for selectively clamping a line subjected to tension; and control means for selectively actuating said clamping means for clamping the line and for de-activating said clamping means for rapidly releasing the line, said control means including a user-responsive element for selecting one of said actuating and releasing modes, said user responsive element being programmable for selection of one of said modes by application of a user force that is significantly less than and unrelated to the tension in the line.

16. A line clamp as defined in claim 15, wherein said clamping means includes an eccentric wheel the outer periphery of which forms a line receiving space with a brake element.

17. A line clamp as defined in claim 16, wherein biasing means are provided for urging said brake element to follow the contour of circumferential periphery of said wheel.

18. A line clamp as defined in claim 17, further comprising biasing means for preventing said toggle means to restrict the movements of said brake in the deactivated condition of said control means.

19. A line clamp as defined in claim 18, wherein said control means includes safety means for preventing said toggle means from snapping to a condition that changes the modes of said control means from actuated to de-actuated.

20. A line clamp as defined in claim 19, wherein said control means includes cam means for destabilizing said toggle means when safety means is de-activated.
